(19) United States
(12) Patent Application Publication
(10) Pub. No.: US 2026/0321069 A1
(43) Pub. Date: Oct. 15, 2026

(54) VIN CODE READING METHOD, VEHICLE COMMUNICATION DEVICE, AND STORAGE MEDIUM

(71) Applicant: Autel Intelligent Technology Corp., Ltd., Shenzhen (CN)

(72) Inventor: Zhipeng DU, Shenzhen (CN)

(73) Assignee: Autel Intelligent Technology Corp., Ltd., Shenzhen (CN)

(21) Appl. No.: 19/690,960

(22) Filed: May 28, 2026

Related U.S. Application Data
(63) Continuation of application No. PCT/CN2024/134027, filed on Nov. 23, 2024.

(30) Foreign Application Priority Data
Nov. 28, 2023 (CN) 202311612278.X

(51) Int. Cl. G07C 5/00; G07C 5/08; H04L 12/40; H04L 67/12

(52) U.S. Cl. CPC G07C 5/008; G07C 5/0808; H04L 12/40032; H04L 67/12; H04L 2012/40215; H04L 2012/40273

(57) ABSTRACT

The present disclosure provides a VIN code reading method, including: when a vehicle communication device is powered on, starting a first read VIN code mode of the vehicle communication device, and reading, in the first read VIN code mode, a first VIN code according to preset instructions within the vehicle communication device; if the first VIN code is not successfully read and at least one of instructions for stopping the first read VIN code mode or instructions for establishing a communication link sent by a host computer are received, starting a second read VIN code mode, and reading, in the second read VIN code mode, a second VIN code according to the vehicle brand associated with the vehicle.

### CROSS-REFERENCE TO RELATED APPLICATIONS

This application is a continuation of PCT Patent Application No. PCT/CN2024/134027, filed on Nov. 23, 2024, which claims priority to Chinese Patent Application No. 202311612278.X, filed on Nov. 28, 2023. The entire disclosures of each of the aforementioned applications are incorporated by reference for all purposes.

### TECHNICAL FIELD

Embodiments of the present disclosure relate to the field of vehicle communication technology, and in particular, to a VIN code reading method, a vehicle communication device, and a storage medium.

### BACKGROUND

A vehicle identification number (VIN) is a set of character codes designated by a vehicle manufacturer for a certain vehicle to identify this vehicle, which is hereinafter referred to as a VIN code. In accordance with the ASE standard, the VIN code consists of 17 characters. Through the VIN code, information such as the producer, production year, vehicle brand, vehicle type, engine model, vehicle model, and assembly location of this vehicle can be queried. Therefore, in a procedure of vehicle diagnosis and maintenance, automatically acquiring the VIN code is crucial for correctly identifying the vehicle model and thus performing correct vehicle diagnosis and maintenance.

Currently, in a technical solution in the related art, before performing diagnosis on the vehicle, a user needs to select the vehicle brand through a terminal device and click a VIN code reading button to read the VIN code. A diagnostic guidance interface for the vehicle of the brand can only be accessed after the VIN code is parsed. Since the user needs to perform manual operations multiple times and make an attempt on combinations of VIN protocols and commands of the vehicle one by one, this technical solution is time-consuming for VIN code acquisition and is not sufficiently intelligent in terms of user experience.

### SUMMARY

Embodiments of the present disclosure provide a VIN code reading method, a vehicle communication device, and a storage medium. A first read VIN code mode of the vehicle communication device is started and a first VIN code is read when the vehicle communication device is powered on, and if the first VIN code is not successfully read, a second read VIN code mode is executed and a second VIN code is read to correct for the VIN code not being read in the first VIN code mode, and thus the present disclosure can reduce the manual operations by a user, and improves VIN code reading efficiency.

In a first aspect, some embodiments of the present disclosure provide a VIN code reading method, performed by a vehicle communication device, including:
when the vehicle communication device is powered on, starting a first read VIN code mode of the vehicle communication device, and reading, in the first read VIN code mode, a first VIN code according to preset instructions within the vehicle communication device; where the vehicle communication device is communicatively connected to a host computer; and
in response to determining that the first VIN code is not successfully read and instructions for stopping the first read VIN code mode or instructions for establishing a communication link sent by the host computer are received, starting a second read VIN code mode, and reading, in the second read VIN code mode, a second VIN code according to a vehicle brand.

In a second aspect, some embodiments of the present disclosure provide a vehicle communication device, including:
one or more processors; and
a memory communicatively connected to the one or more processors; where
the memory stores instructions executable by the one or more processors, and the instructions are executed by the one or more processors to enable the one or more processors to execute the VIN code reading method according to the first aspect.

In a third aspect, some embodiments of the present disclosure provide a non-transitory computer-readable storage medium, having computer programs or instructions stored therein, the computer programs or instructions, when executed by a processor, causes the processor to perform the VIN code reading method according to the first aspect.

### BRIEF DESCRIPTION OF DRAWINGS

One or more embodiments are exemplarily illustrated by the corresponding accompanying drawings, and these exemplary illustrations do not constitute limitations on the embodiments. Elements with the same reference numerals in the accompanying drawings are represented as similar elements. Unless otherwise stated, the figures in the accompanying drawings do not constitute scale limitations.

FIG. 1 is a schematic diagram of an application environment according to an embodiment of the present disclosure;

FIG. 2 is a schematic flow diagram of a VIN code reading method according to an embodiment of the present disclosure;

FIG. 3 is a schematic detailed flow diagram of step S201 in FIG. 2;

FIG. 4 is a schematic detailed flow diagram of step S2011 in FIG. 3;

FIG. 5 is a schematic detailed flow diagram of step S2012 in FIG. 3;

FIG. 6 is a schematic flow diagram of determining a second read VIN code mode according to an embodiment of the present disclosure;

FIG. 7 is a schematic detailed flow diagram of step S604 in FIG. 6;

FIG. 8 is a schematic detailed flow diagram of step S643 in FIG. 7;

FIG. 9 is a schematic detailed flow diagram of step S606 in FIG. 6;

FIG. 10 is a schematic structural diagram of a VIN code reading apparatus according to an embodiment of the present disclosure; and

FIG. 11 is a schematic structural diagram of a vehicle communication device according to an embodiment of the present disclosure.

The explanation of reference numerals is shown in Table 1:

TABLE 1

| Reference | | Reference | |
|---|---|---|---|
| numeral | Name | numeral | Name |
| 100 | Application environment | 1001 | First VIN code reader |
| 10 | Vehicle communication | 1002 | Second VIN code |
| | device | | reader |
| 20 | Host computer | 101 | Processor |
| 30 | Vehicle electronic | 102 | Memory |
| | controller | | |
| 1000 | VIN code reading | | |
| | apparatus | | |

### DETAILED DESCRIPTION

For the convenience of understanding the present disclosure, the present disclosure will be described in more detail below with reference to the accompanying drawings and specific embodiments. It should be noted that when an element is referred to as being “fixed to” another element, the element may be directly on another element or there may be one or more intermediate elements between them. When an element is referred to as being “connected” to another element, the element may be directly connected to another element or there may be one or more intermediate elements between them. The terms “perpendicular”, “horizontal”, “left”, “right” and similar expressions used in this specification are only for illustrative purposes.

Unless otherwise defined, all technical and scientific terms used in this specification have the same meanings as those commonly understood by those skilled in the technical field to which the present disclosure belongs. In the specification, the terms used in the specification of the present disclosure are only for the purpose of describing specific embodiments, and are not used for limiting the present disclosure. The term “and/or” used in this specification includes any and all combinations of one or more of the related listed items.

The technical solutions of the present disclosure will be specifically described below with reference to the accompanying drawings of the specification.

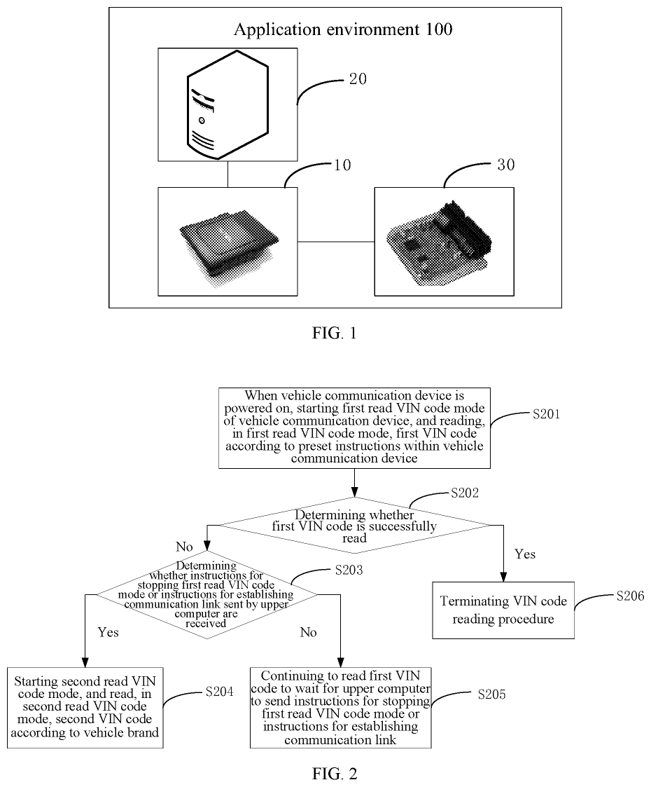

FIG. 1 is a schematic diagram of an application environment according to an embodiment of the present disclosure.

As shown in FIG. 1, the application environment 100 includes: a vehicle communication device 10, a host computer 20, and a vehicle electronic controller 30, where the host computer 20 is communicatively connected to the vehicle communication device 10 in a wired or wireless mode, and where the wired mode includes a USB connection mode, and the wireless mode includes Bluetooth, WiFi, 4G, 5G network cables and other connection modes. The vehicle communication device 10 is communicatively connected to the vehicle electronic controller 30 through a bus.

In the embodiment of the present disclosure, the vehicle communication device 10 refers to a vehicle communication interface (VCI) of a vehicle diagnostic device. After the vehicle communication device is wiredly connected to an On-Board Diagnostics (OBD) socket of a vehicle, the vehicle diagnostic device may be connected to the vehicle communication device in a wired or wireless mode to perform diagnosis on the vehicle. The vehicle communication device 10 is a lower computer of the host computer 20, and the vehicle communication device 10 is used for: when the vehicle communication device is powered on, starting a first read VIN code mode of the vehicle communication device, and reading, in the first read VIN code mode, a first VIN code according to preset instructions within the vehicle communication device; and if the first VIN code is not successfully read and instructions for stopping the first read VIN code mode or instructions for establishing a communication link sent by the host computer are received, starting a second read VIN code mode, and reading, in the second read VIN code mode, a second VIN code according to a vehicle brand.

In the embodiment of the present disclosure, the host computer 20 may be a server, and may also be a terminal, which is not limited in the present disclosure.

In the embodiment of the present disclosure, when the host computer 20 is the server, the host computer 20 is used for sending a vehicle brand configuration list to the vehicle communication device. The number of the servers 20 is multiple, and the multiple servers may form a server cluster. For example, the server cluster includes: a first server, a second server, . . . , an Nth server, or the server cluster may be a cloud computing service center, and the cloud computing service center includes several servers. The servers in the embodiments of the present disclosure include but are not limited to: tower servers, rack servers, blade servers, and cloud servers. Preferably, the server is an Elastic Compute Service (ECS) cloud server.

In the embodiment of the present disclosure, when the host computer 20 is the terminal, the host computer 20 is used for sending instructions for establishing a communication link and communicating on the communication link to the vehicle communication device. The types of the terminal include but are not limited to: smart phones, tablet computers, or other electronic devices.

It can be understood that the host computer in the embodiments of the present disclosure further includes a storage module, and the storage module includes but is not limited to one or more of a FLASH memory, an NAND flash memory, a vertical NAND (VNAND) flash memory, a NOR flash memory, a resistive random access memory (RRAM), a magnetoresistive random access memory (MRAM), a ferroelectric random access memory (FRAM), a spin-transfer torque random access memory (STT-RAM) and other devices.

In the embodiment of the present disclosure, the vehicle electronic controller 30 is disposed inside the vehicle, and the vehicle electronic controller is used for communicating with the vehicle communication device 10 through a bus. For example, after the communication link is successfully established, the vehicle communication device 10 sends instructions for reading a VIN to the vehicle electronic controller 30, and the vehicle electronic controller 30 returns the VIN code to the vehicle communication device 10. The vehicle electronic controller may be a general-purpose processor, a digital signal processor (DSP), an application-specific integrated circuit (ASIC), a field-programmable gate array (FPGA), a single-chip microcomputer, an Acorn RISC Machine (ARM) or other programmable logic devices, discrete gate or transistor logic, discrete hardware components, or any combination of these components. The vehicle electronic controller may also be any conventional processor, controller, microcontroller, or state machine. The vehicle electronic controller may also be implemented as a combination of computing devices, for example, a combination of a DSP and a microprocessor, multiple microprocessors, one or more microprocessors combined with a DSP and/or any other such configuration, or one or more combinations of a Microcontroller Unit (MCU), a Field-Programmable Gate Array (FPGA), and a System on Chip (SoC).

FIG. 2 is a schematic flow diagram of a VIN code reading method according to an embodiment of the present disclosure.

The VIN code reading method is applied to a vehicle communication device, and the vehicle communication device is communicatively connected to a host computer. In an embodiment, an execution subject of the VIN code reading method is one or at least two processors of the vehicle communication device.

As shown in FIG. 2, the VIN code reading method, includes:

step S201: when the vehicle communication device is powered on, starting a first read VIN code mode of the vehicle communication device, and reading, in the first read VIN code mode, a first VIN code according to preset instructions within the vehicle communication device.

In the embodiment of the present disclosure, a vehicle communication interface (VCI) communicates with a vehicle by being connected to an On-Board Diagnostics (OBD) interface of the vehicle. For the vehicle communication device, the conventional power-on operation is to insert the vehicle communication device into the OBD interface of the vehicle, and a vehicle power supply supplies power to the vehicle communication device through the OBD interface. Generally, at this time, the host computer has not been connected to the vehicle communication device. By utilizing a period of time during which the host computer has not been connected to the vehicle communication device, the first read VIN code mode of the vehicle communication device is started after power-on, and the first VIN code is read according to the preset instructions within the vehicle communication device in the first read VIN code mode. The present disclosure can save the time for subsequent vehicle diagnosis.

In an embodiment, the first read VIN code mode is used for reading the first VIN code according to the preset instructions within the vehicle communication device, and the first read VIN code mode includes a forced VIN code reading mode and a rapid VIN code reading mode.

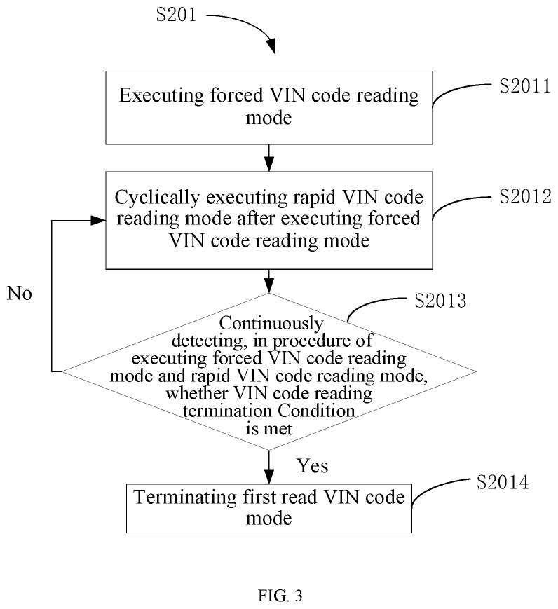

FIG. 3 is a schematic detailed flow diagram of step S201 in FIG. 2.

As shown in FIG. 3, step S201: when the vehicle communication device is powered on, starting a first read VIN code mode of the vehicle communication device, and reading, in the first read VIN code mode, a first VIN code according to preset instructions within the vehicle communication device, includes:

step S2011: executing the forced VIN code reading mode.

In the embodiment of the present disclosure, the first read VIN code mode of the vehicle communication device includes the forced VIN code reading mode and the rapid VIN code reading mode, and the forced VIN code reading mode is firstly executed.

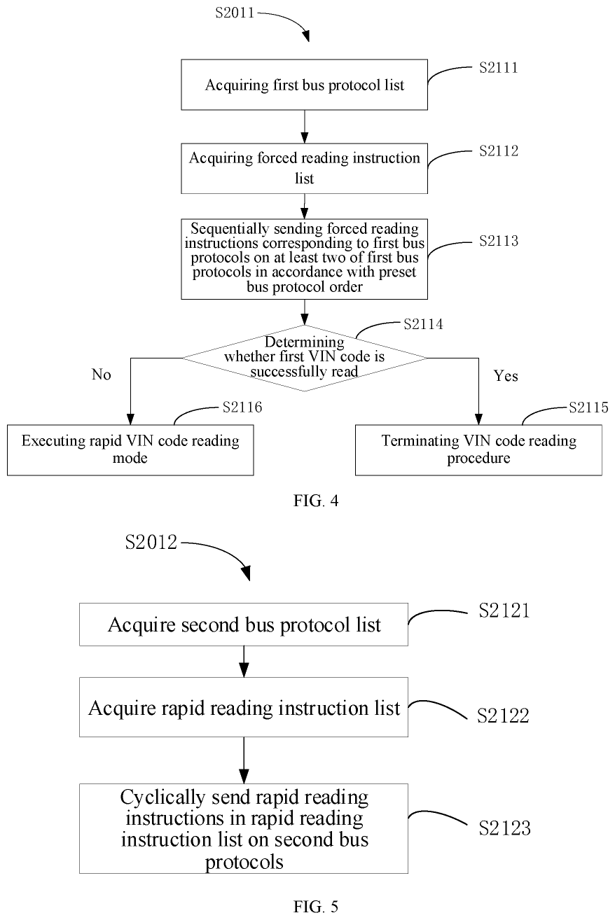

FIG. 4 is a schematic detailed flow diagram of step S2011 in FIG. 3.

As shown in FIG. 4, step S2011: executing the forced VIN code reading mode, includes:

step S2111: acquiring a first bus protocol list.

In an embodiment, the vehicle communication device acquires the first bus protocol list, and the first bus protocol list includes a plurality of first bus protocols. For example, the first bus protocol list includes an Iso15765 protocol, a Pwm protocol, a Vpw protocol, a Kwp14230 protocol, and an Iso9141 protocol, where the Iso15765 protocol is a diagnostic protocol on a CAN bus, the Pwm protocol is an analog signal protocol which transmits signals by controlling pulse widths of analog signals, the Variable Pulse Width (Vpw) protocol is a vehicle bus communication mode based on variable pulse width modulation, the Kwp14230 protocol is a keyword protocol, and the Iso9141 protocol is one of the standard OBDII protocols.

Step S2112: acquiring a forced reading instruction list.

In an embodiment, the forced reading instruction list is acquired, where the forced reading instruction list includes a plurality of forced reading instructions, and the forced reading instructions are in one-to-one correspondence with the first bus protocols. Each protocol is provided with a corresponding forced reading instruction thereof, where specific contents of the forced reading instructions include pins, baud rates, and instructions for reading the first VIN code. For example, when the first bus protocol is the Iso15765 protocol, the specific contents in the forced reading instructions corresponding to the first bus protocol include a pair of pins No. 6 and No. 14, where the pin No. 6 is CAN-H, and the pin No. 14 is CAN-L, a baud rate of 500 Kbps or 250 Kbps, and instructions for reading the first VIN code; and when the first bus protocol is the Iso9141 protocol, the specific contents in the forced reading instructions corresponding to the first bus protocol include pins No. 7 and No. 15, a baud rate of 10,400 bps, and instructions for reading the first VIN code.

Step S2113: sequentially sending the forced reading instructions corresponding to the first bus protocols on at least two of the first bus protocols in accordance with a preset bus protocol order.

In an embodiment, the forced reading instructions corresponding to the first bus protocols are sequentially sent on at least two of the first bus protocols in accordance with the preset bus protocol order. Preferably, the preset bus protocol order is set to be the Iso15765 protocol, the Pwm protocol, the Vpw protocol, the Kwp14230 protocol, and the Iso9141 protocol. For example, the forced reading instructions corresponding to the Iso15765 protocol are sent on the Iso15765 protocol, and a response of the vehicle is waited for. The response of the vehicle refers to a reply frame sent by a vehicle electronic control unit (ECU), and contents of the reply frame include the first VIN code.

In the embodiment of the present disclosure, the forced reading instruction is in the form of an instruction frame, and the instruction frame consists of two parts, namely, an address and data. The forced reading instructions are in one-to-one correspondence with the first bus protocols. For example, when the first bus protocol is the Iso15765 protocol, if the protocol is an 11-bit CAN, the data part of the instruction frame is 07 df 09 02; if the protocol is a 29-bit CAN, the data part of the instruction frame is 18 DB 33 F1 09 02; when the first bus protocol is the Iso9141 protocol, the data part of the instruction frame is 68 6A F1 09 02 66; when the first bus protocol is the Kwp14230 protocol, the data part of the instruction frame is C2 33 F1 09 02 F1; when the first bus protocol is the Vpw protocol, the data part of the instruction frame is 06 68 6A F1 09 02 77; and when the first bus protocol is the Pwm protocol, the data part of the instruction frame is 06 61 6A F1 09 02 6A.

Step S2114: determining whether the first VIN code is successfully read.

In an embodiment, after sending the forced reading instructions corresponding to the first bus protocols on the first bus protocol each time, it is determined whether the first VIN code is successfully read. If the first VIN code is not successfully read this time, the forced reading instruction corresponding to the next first bus protocol is sent on the next first bus protocol in accordance with the preset bus protocol order. If the first VIN code is still not successfully read after traversing the first bus protocol list, step S2116 is entered; and if the first VIN code is successfully read, step S2115 is entered.

Step S2115: terminating a VIN code reading procedure.

In an embodiment, if the first VIN code is successfully read, it indicates that the VIN code of the vehicle has been acquired, and the VIN code reading procedure is terminated.

Step S2116: executing the rapid VIN code reading mode.

In an embodiment, if the first VIN code is not successfully read, it indicates that the VIN code of the vehicle has not been acquired, and the rapid VIN code reading mode is executed to further acquire the first VIN code of the vehicle. The specific implementation mode of the rapid VIN code reading mode is described in detail in FIG. 5 below, which will not be elaborated herein to avoid repetition.

Step S2012: cyclically executing the rapid VIN code reading mode after executing the forced VIN code reading mode.

FIG. 5 is a schematic detailed flow diagram of step S2012 in FIG. 3.

As shown in FIG. 5, step S2012: after executing the forced VIN code reading mode, cyclically executing the rapid VIN code reading mode, includes:

step S2121: acquiring a second bus protocol list.

In an embodiment, the vehicle communication device acquires the second bus protocol list, and the second bus protocol list includes at least one second bus protocol. Preferably, the second bus protocol list includes one second bus protocol. For example, the second bus protocol list includes the Iso15765 protocol.

In the embodiment of the present disclosure, the number of second bus protocols included in the second bus protocol list is less than the number of first bus protocols included in the first bus protocol list. Therefore, compared with the above forced VIN code reading mode, the rapid VIN code reading mode can acquire the first VIN code of the vehicle in a more rapid mode. Moreover, preferably, setting bus protocols commonly used under actual conditions in the second bus protocol list can reduce the risk of vehicle code forgery.

Step S2122: acquiring a rapid reading instruction list.

In an embodiment, the rapid reading instruction list is acquired, where the rapid reading instruction list includes at least one rapid reading instruction, each rapid reading instruction corresponds to one second bus protocol, and each second bus protocol may correspond to a plurality of rapid reading instructions. Specific contents of the rapid reading instructions include pins, baud rates, and instructions for reading the first VIN code. For example, when the second bus protocol is the Iso15765 protocol, specific contents in the rapid reading instructions corresponding to the second bus protocol include a pair of pins No. 6 and No. 14, where the pin No. 6 is CAN-H, and the pin No. 14 is CAN-L, a baud rate of 500 Kbps or 250 Kbps, and instructions for reading the first VIN code.

Step S2123: cyclically sending the rapid reading instructions in the rapid reading instruction list on the second bus protocols.

In an embodiment, the rapid reading instructions corresponding to the second bus protocols are cyclically sent on the second bus protocols, and a response of the vehicle is waited for. The response of the vehicle refers to a reply frame sent by the vehicle ECU, and contents of the reply frame include the first VIN code.

It should be noted that the reason for firstly reading the vehicle VIN code by using the forced VIN code reading mode and then executing the rapid VIN code reading mode to cyclically send the rapid reading instructions on the second bus protocols is that under actual conditions, some vehicles will not reply even if the instructions for reading the VIN code are sent in accordance with the matching protocol when an ignition switch is not turned on, and the VIN code cannot be successfully read. However, whether the ignition switch of the vehicle is turned on cannot be known in a procedure of the vehicle communication device executing the first read VIN code mode. If the vehicle already has a condition for replying the instructions for reading the VIN during the forced VIN code reading mode, where the condition for replying the instructions for reading the VIN means that the ignition switch of the vehicle has been turned on, the forced VIN code reading mode tries the instructions for reading the VIN code of various protocols, and the VIN can definitely be successfully read when the protocols and instructions match with the vehicle electronic controller of the vehicle. However, if the vehicle does not have the condition for replying the instructions for reading the VIN code during the forced VIN code reading mode, for example, the ignition switch is not turned on, the forced VIN code reading mode needs to be continuously tried until the vehicle has the condition for replying the instructions for reading the VIN code, and the VIN code is obtained. However, considering that under actual conditions, the VIN code reading protocols of most vehicles are a few commonly used individual protocols, such as the Iso15765 protocol, in the subsequent procedure, it is only necessary to continuously make an attempt on this type of protocol and wait for the vehicle to have the condition and reply the instructions for reading the VIN code of the protocol, instead of repeatedly making an attempt on all protocols of the forced VIN code reading mode. The advantage of this design is that the VIN code reading is continuously tried subsequently, thereby being more rapid and efficient, covering most vehicles, and avoiding code forgery as much as possible (if messages are sent by using mismatched protocols on the vehicle bus, error codes may be forged, leading a user to think that the vehicle is damaged). The forced VIN code reading mode has a higher probability of code forgery than the rapid VIN code reading mode. Therefore, it is necessary to cyclically send the rapid reading instructions on the second bus protocols at this time, so that the VIN code can be read immediately when the ignition switch of the vehicle is turned on.

In the embodiment of the present disclosure, the rapid reading instruction is in the form of an instruction frame, and the instruction frame consists of two parts, namely, an address and data. The rapid reading instructions are in one-to-one correspondence with the second bus protocols. For example, when the second bus protocol is the Iso15765 protocol, if the protocol is an 11-bit CAN, the data part of the instruction frame is 07 df 09 02; and if the protocol is a 29-bit CAN, the data part of the instruction frame is 18 DB 33 F1 09 02.

Step S2013: continuously detecting, in a procedure of executing the forced VIN code reading mode and the rapid VIN code reading mode, whether a VIN code reading termination condition is met.

In an embodiment, in the procedure of executing the forced VIN code reading mode and the rapid VIN code reading mode, whether the VIN code reading termination condition is met is continuously detected, that is, in a procedure of executing the entire first read VIN code mode, whether the VIN code reading termination condition is met is continuously detected, where the VIN code reading termination condition includes successfully reading a VIN code, and/or sending instructions for establishing a communication link by the host computer, and/or disconnecting the vehicle communication device from the vehicle diagnostic interface, and/or sending instructions for stopping the first read VIN code mode by the host computer, and/or being in an upgrade procedure of the vehicle communication device. If the VIN code reading termination condition is not met, it is returned to step S2012 to continue to cyclically execute the rapid VIN code reading mode; and if the VIN code reading termination condition is met, step S2014 is entered.

Step S2014: terminating the first read VIN code mode.

In an embodiment, the VIN code reading termination condition includes: successfully reading a VIN code in the first read VIN code mode, and/or sending instructions for establishing a communication link by the host computer, and/or disconnecting the vehicle communication device from the vehicle diagnostic interface, and/or sending instructions for stopping the first read VIN code mode by the host computer, and/or being in an upgrade procedure of the vehicle communication device. If the VIN code reading termination condition is met, the first read VIN code mode is terminated.

Step S202: determining whether the first VIN code is successfully read.

In an embodiment, after terminating the first read VIN code mode, it is determined whether the first VIN code is successfully read in the first read VIN code mode, that is, it is determined whether the first VIN code is successfully read through the forced VIN code reading mode and the rapid VIN code reading mode. If the first VIN code is not successfully read, step S203 is entered; and if the first VIN code is successfully read, step S206 is entered.

Step S203: determining whether instructions for stopping the first read VIN code mode or instructions for establishing a communication link sent by the host computer are received.

In the embodiment of the present disclosure, the host computer includes two types: a terminal and a server, which are respectively used for sending instructions for establishing a communication link and instructions for stopping the first read VIN code mode. For example, when the host computer is the terminal, the instructions sent by the host computer are the instructions for establishing the communication link; and when the host computer is the server, the instructions sent by the host computer are the instructions for stopping the first read VIN code mode.

In an embodiment, when the first VIN code is not successfully read, the vehicle communication device determines whether the instructions for stopping the first read VIN code mode or the instructions for establishing the communication link sent by the host computer are received. If the instructions for stopping the first read VIN code mode or the instructions for establishing the communication link sent by the host computer are received, step S204 is entered; and if the instructions for stopping the first read VIN code mode or the instructions for establishing the communication link sent by the host computer are not received, step S205 is entered.

Step S204: starting a second read VIN code mode, and reading, in the second read VIN code mode, a second VIN code according to a vehicle brand.

In an embodiment, if the first VIN code is not successfully read in the first read VIN code mode, and the instructions for stopping the first read VIN code mode or the instructions for establishing the communication link sent by the host computer are received, the first read VIN code mode is stopped, and the second read VIN code mode is executed to read the second VIN code, where the second read VIN code mode is used for reading the second VIN code according to the vehicle brand of the vehicle.

In the embodiment of the present disclosure, when the first VIN code is not successfully read in the first read VIN code mode, in the present disclosure, the VIN code can also be read through the second read VIN code mode to improve the success rate of VIN code reading. It can be known that the design idea of the first read VIN code mode is to repeatedly make an attempt on commonly used protocols and instructions to acquire the VIN code, and there is a possibility that the VIN code cannot be successfully read. A few special vehicle models cannot be covered by these conventional protocols and instructions, but it is not feasible to make an attempt on all possible protocols and commands, which will reduce the efficiency of the first read VIN code mode and increase the risk of code forgery. Therefore, when the VIN is not successfully read in the first read VIN mode, the second read VIN mode is used for making up for the performance defect of this function. The VIN is read in the second read VIN code mode in accordance with the possible protocols and commands of the specific vehicle brand, and the scope of this set is much smaller. By adjusting the order of attempts, it is also possible to interact with the ECU of the vehicle of the brand to ascertain communication attributes of the ECU of the vehicle where the VIN code is stored. In addition, human-machine interface interaction may also prompt the user according to the vehicle brand that the ignition switch of the vehicle needs to be turned on to read the VIN. Through the above methods, the second read VIN code mode is designed to basically ensure that the VIN is successfully read without code forgery; however, the disadvantage is that it requires the user to perform human-machine interaction, which is relatively slow and not sufficiently intelligent, where the human-machine interaction means that the user needs to click buttons and select the vehicle brand.

Step S205: continuing to read the first VIN code to wait for the host computer to send instructions for stopping the first read VIN code mode or instructions for establishing a communication link.

In an embodiment, when the vehicle communication device does not receive the instructions for stopping the first read VIN code mode or the instructions for establishing the communication link sent by the host computer, the first VIN code reading is continued to wait for the host computer to send the instructions for stopping the first read VIN code mode or the instructions for establishing the communication link.

Step S206: terminating a VIN code reading procedure.

In an embodiment, if the first VIN code has been read in the first read VIN code mode, the VIN code reading procedure is terminated.

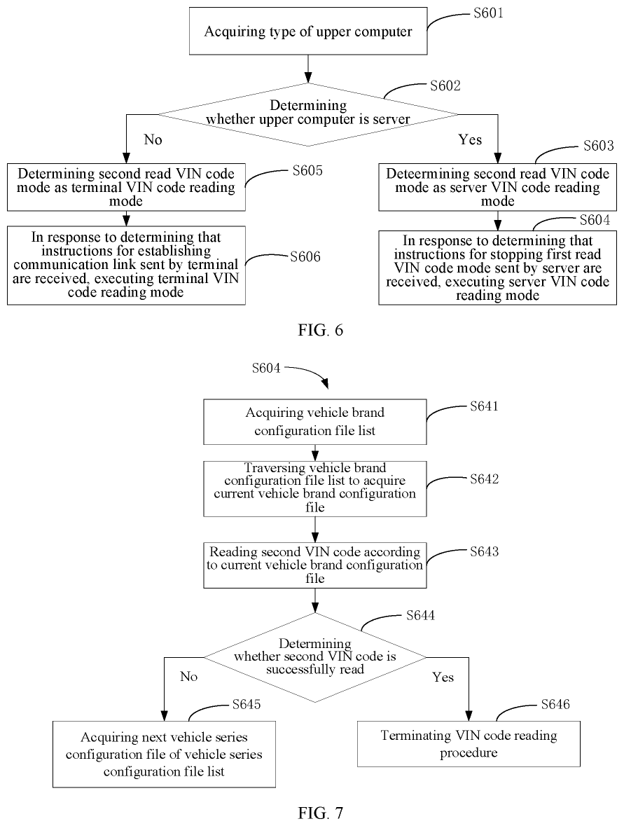

FIG. 6 is a schematic flow diagram of determining a second read VIN code mode according to an embodiment of the present disclosure.

As shown in FIG. 6, the flow of determining the second read VIN code mode, includes:

step S601: acquiring a type of the host computer.

In an embodiment, the vehicle communication device is communicatively connected to the host computer. The types of the host computer include a server and a terminal, and the second read VIN code mode includes a server VIN code reading mode and a terminal VIN code reading mode. The type of the host computer is acquired, and in subsequent operations, the second read VIN code mode is ascertained as the server VIN code reading mode or the terminal VIN code reading mode according to the type of the host computer.

Step S602: determining whether the host computer is the server.

In an embodiment, whether the host computer is the server is determined. If the host computer is the server, step S603 is entered; and if the host computer is not the server, step S605 is entered.

Step S603: determining the second read VIN code mode as the server VIN code reading mode.

In an embodiment, when the host computer is the server, preferably, the host computer is a cloud server, and the second read VIN code mode is ascertained as the server VIN code reading mode.

Step S604: in response to determining that instructions for stopping the first read VIN code mode sent by the server are received, executing the server VIN code reading mode.

In an embodiment, after determining the second read VIN code mode as the server VIN code reading mode, the server sending the instructions for stopping the first read VIN code mode is waited for. If the instructions for stopping the first read VIN code mode sent by the server are received, the execution of the server VIN code reading mode is started.

FIG. 7 is a schematic detailed flow diagram of step S604 in FIG. 6.

As shown in FIG. 7, step S604: in response to determining that instructions for stopping the first read VIN code mode sent by the server are received, executing the server VIN code reading mode, includes:

step S641: acquiring a vehicle brand configuration file list.

In an embodiment, due to the diversity of vehicle brands of vehicles, the configuration files of each vehicle brand are different, that is, the communication attributes for acquiring the VIN code of the vehicle of each vehicle brand are different, where the communication attributes include pins, baud rates and bus protocols for the vehicle to establish a communication link. Divided by the vehicle brand, a plurality of vehicle brand configuration files may be obtained, and a set of the plurality of vehicle brand configuration files is the vehicle brand configuration file list. The vehicle brand configuration file list is preset within the server, and the vehicle brand configuration file list includes at least one vehicle brand configuration file. The vehicle brand configuration file includes instructions for establishing a communication link and communication attributes thereof, instructions for entering a system, instructions for reading a VIN code, as well as execution orders and timing parameters of these instructions. When the server ascertains that the VIN code is not successfully read in the first read VIN code mode, the server sends the instructions for stopping the first read VIN code mode to the vehicle communication device, and then sends the vehicle brand configuration file list to the vehicle communication device immediately, so as to enable the vehicle communication device to acquire the vehicle brand configuration file list.

Step S642: traversing the vehicle brand configuration file list to acquire a current vehicle brand configuration file.

In an embodiment, the vehicle communication device traverses the vehicle brand configuration file list which includes at least one vehicle brand configuration file, acquires one vehicle brand configuration file from the vehicle brand configuration file list, and ascertains the vehicle brand configuration file as the current vehicle brand configuration file.

Step S643: reading the second VIN code according to the current vehicle brand configuration file.

FIG. 8 is a schematic detailed flow diagram of step S643 in FIG. 7.

As shown in FIG. 8, step S643: reading the second VIN code according to the current vehicle brand configuration file, includes:

step S6431: reading the second VIN code according to the instructions for establishing the communication link, the instructions for entering the system, the instructions for reading the VIN code, as well as the execution orders and the timing parameters between the instructions for establishing the communication link, the instructions for entering the system and the instructions for reading the VIN code.

In an embodiment, the vehicle brand configuration file includes the instructions for establishing the communication link and the communication attributes thereof, the instructions for entering the system, the instructions for reading the VIN code, as well as the execution orders and the timing parameters of these instructions, where the instructions for entering the system refer to instructions for activating the vehicle electronic controller, the execution order refers to a sending order of all the instructions, and the timing parameter refers to a sending time interval between all the instructions. According to the current vehicle brand configuration file, the communication link is established strictly in accordance with these configurations, and the instructions are sent in accordance with the order of the instructions and the execution order and timing parameters between the instructions to read the second VIN code. For example, the communication link is established according to the communication attributes such as the pins, baud rates and bus protocols, communication with the vehicle electronic controller is performed through the communication link, and then the instructions for reading the VIN code are sent to the vehicle electronic controller to read the second VIN code.

Step S644: determining whether the second VIN code is successfully read.

In an embodiment, the vehicle brand configuration file includes the instructions for establishing the communication link and the communication attributes thereof, the instructions for entering the system, the instructions for reading the VIN code, as well as the execution orders and the timing parameters of these instructions. According to the current vehicle brand configuration file, the communication link is established strictly in accordance with these configurations, the second VIN code is read in accordance with the order of the instructions and the timing between the instructions, and then it is determined whether the second VIN code is successfully read. If the second VIN code is successfully read, step S646 is entered; and if the second VIN code is not successfully read, step S645 is entered.

Step S645: acquiring a next vehicle brand configuration file of the vehicle brand configuration file list.

In an embodiment, if the second VIN code is not successfully read, the next vehicle brand configuration file of the vehicle brand configuration file list is acquired until all vehicle brand configuration files in the vehicle brand configuration file list are traversed.

Step S646: terminating the VIN code reading procedure.

In an embodiment, if the second VIN code is successfully read, the VIN code reading procedure is terminated.

Step S605: determining the second read VIN code mode as the terminal VIN code reading mode.

In an embodiment, when the host computer is not the server, it is ascertained that the host computer is the terminal, and the second read VIN code mode is ascertained as the terminal VIN code reading mode. It should be noted that the terminal includes but is not limited to smart phones and tablet computers.

Step S606: in response to determining that the instructions for establishing the communication link sent by the terminal are received, executing the terminal VIN code reading mode.

In an embodiment, after determining the second read VIN code mode as the terminal VIN code reading mode, the terminal sending the instructions for establishing the communication link is waited for. If the instructions for establishing the communication link sent by the terminal are received, the execution of the terminal VIN code reading mode is started.

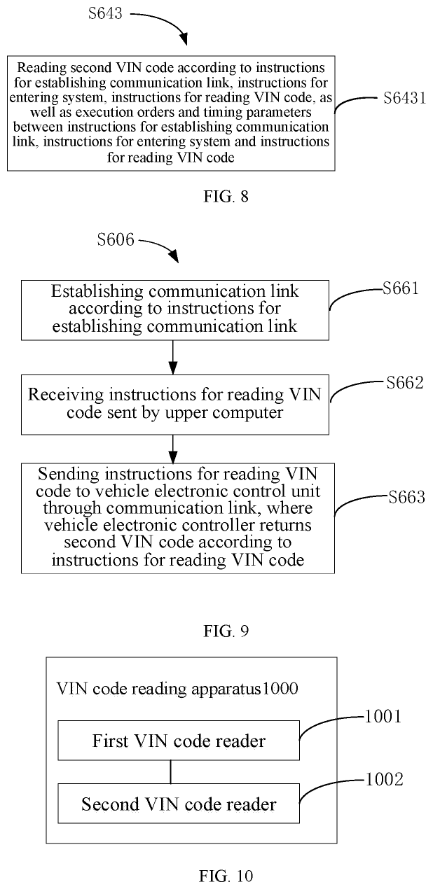

FIG. 9 is a schematic detailed flow diagram of step S606 in FIG. 6.

As shown in FIG. 9, step S606: in response to determining that the instructions for establishing the communication link sent by the terminal are received, executing the terminal VIN code reading mode, includes:

step S661: establishing the communication link according to the instructions for establishing the communication link.

In an embodiment, in the terminal VIN code reading mode, the terminal is the host computer of the vehicle communication device, and the vehicle communication device receives the instructions for establishing the communication link sent by the terminal. It should be noted that the instructions for establishing the communication link are instructions sent by the user by controlling the terminal according to the vehicle brand of the vehicle. The instructions for establishing the communication link include pins, baud rates and bus protocols. After receiving the instructions for establishing the communication link, the communication link between the vehicle communication device and the vehicle electronic controller is established according to the pins, baud rates and bus protocols.

Step S662: receiving the instructions for reading the VIN code sent by the host computer.

In an embodiment, after establishing the communication link between the vehicle communication device and the vehicle electronic controller, the instructions for reading the VIN code sent by the host computer are received.

Step S663: sending the instructions for reading the VIN code to the vehicle electronic controller through the communication link, where the vehicle electronic controller returns the second VIN code according to the instructions for reading the VIN code.

In an embodiment, according to the instructions for reading the VIN code sent by the host computer, the instructions for reading the VIN code are sent to the vehicle electronic controller through the communication link, so as to enable the vehicle electronic controller to return the second VIN code to the vehicle communication device after receiving the instructions for reading the VIN code, and then the vehicle communication device sends the second VIN code to the host computer.

In the embodiment of the present disclosure, the difference between the server VIN code reading mode and the terminal VIN code reading mode is that when the host computer is the server, it is necessary to make an attempt on the vehicle brand configuration files in the vehicle brand configuration file list one by one; and when the host computer is the terminal, the user selects the vehicle brand at the terminal to enter a diagnostic page of the brand, and then clicks a button for automatically reading the VIN code to trigger the second read VIN code mode, so that the vehicle brand is ascertained and unique. It is only necessary to establish the communication link according to the instructions and then send the instructions for reading the VIN code of the vehicle brand to the vehicle electronic controller to acquire the second VIN code.

In summary, the advantage of the server VIN code reading mode is that the VIN code of the vehicle can be acquired even when the vehicle brand of the vehicle is unknown, and the server VIN code reading mode does not require the user to operate to select the vehicle brand and click the button for automatically reading the VIN code, that is, it reduces the operations by the user and is more intelligent; and the terminal VIN code reading mode requires the above operations, which is equivalent to the vehicle brand being known, the advantage thereof is that the efficiency of acquiring the VIN code of the vehicle can be improved, and the disadvantage thereof is that it is not sufficiently intelligent.

In the embodiment of the present disclosure, a VIN code reading method is provided, being applied to a vehicle communication device, where the vehicle communication device is communicatively connected to a host computer. The VIN code reading method includes: when the vehicle communication device is powered on, starting a first read VIN code mode of the vehicle communication device, and reading, in the first read VIN code mode, a first VIN code according to preset instructions within the vehicle communication device; if the first VIN code is not successfully read and instructions for stopping the first read VIN code mode or instructions for establishing a communication link sent by the host computer are received, starting a second read VIN code mode, and reading, in the second read VIN code mode, a second VIN code according to a vehicle brand. The first read VIN code mode of the vehicle communication device is started and the first VIN code is read when the vehicle communication device is powered on, and if the first VIN code is not successfully read, the second read VIN code mode is executed and the second VIN code is read to correct for the VIN code not being read in the first read VIN code mode, and thus the present disclosure can reduce the manual operations by a user, and improves VIN code reading efficiency.

FIG. 10 is a schematic structural diagram of a VIN code reading apparatus according to an embodiment of the present disclosure.

The VIN code reading apparatus is applied to a vehicle communication device. In an embodiment, the VIN code reading apparatus is applied to one or more processors of the vehicle communication device.

As shown in FIG. 10, the VIN code reading apparatus 1000 includes:
a first VIN code reader 1001 used for: when the vehicle communication device is powered on, starting a first read VIN code mode of the vehicle communication device, and reading, in the first read VIN code mode, a first VIN code according to preset instructions within the vehicle communication device; and
a second VIN code reader 1002 used for: in response to determining that the first VIN code is not successfully read and instructions for stopping the first read VIN code mode or instructions for establishing a communication link sent by a host computer are received, starting a second read VIN code mode, and reading, in the second read VIN code mode, a second VIN code according to a vehicle brand.

In the embodiment of the present disclosure, the first VIN code reader 1001 is specifically used for:
executing a forced VIN code reading mode;
cyclically executing a rapid VIN code reading mode after executing the forced VIN code reading mode;
continuously detecting, in a procedure of executing the forced VIN code reading mode and the rapid VIN code reading mode, whether a VIN code reading termination condition is met, where the VIN code reading termination condition includes successfully reading a VIN code, receiving instructions for establishing a communication link sent by the host computer, receiving instructions for stopping the first read VIN code mode sent by the host computer, or disconnecting the vehicle communication device from a vehicle diagnostic interface; and
in response to determining that the VIN code reading termination condition is met, terminating the first read VIN code mode.

In the embodiment of the present disclosure, the second VIN code reader 1002 is specifically used for:
when the host computer is a server, determining the second read VIN code mode as a server VIN code reading mode; in response to determining that instructions for stopping the first read VIN code mode sent by the server are received, executing the server VIN code reading mode; and
when the host computer is a terminal, determining the second read VIN code mode as a terminal VIN code reading mode; in response to determining that instructions for establishing a communication link sent by the terminal are received, executing the terminal VIN code reading mode.

In the embodiment of the present disclosure, the VIN code reading apparatus may also be built by hardware devices. For example, the VIN code reading apparatus may be built by one or more than two chips, and various chips may cooperate with each other to complete the VIN code reading method described in the various embodiments above. For another example, the VIN code reading apparatus may also be built by various types of logic devices, for example, built by a general-purpose processor, a digital signal processor (DSP), an application-specific integrated circuit (ASIC), a field-programmable gate array (FPGA), a single-chip microcomputer, an Acorn RISC Machine (ARM) or other programmable logic devices, discrete gate or transistor logic, discrete hardware components, or any combination of these components.

The VIN code reading apparatus in the embodiment of the present disclosure may be an apparatus, and may also be a component, an integrated circuit, or a chip in the terminal. The apparatus may be a mobile electronic device, and may also be a non-mobile electronic device. Exemplarily, the mobile electronic device may be a mobile phone, a tablet computer, a notebook computer, a palm computer, an on-board electronic device, a wearable device, an ultra-mobile personal computer (UMPC), a netbook, or a personal digital assistant (PDA), and the like; and the non-mobile electronic device may be a server, a Network Attached Storage (NAS), a personal computer (PC), a television (TV), an automatic teller machine, or a self-service machine, and the like, which is not specifically limited in the embodiment of the present disclosure.

The VIN code reading apparatus in the embodiment of the present disclosure may be an apparatus with an operating system. The operating system may be an Android operating system, an ios operating system, or other possible operating systems, which is not specifically limited in the embodiment of the present disclosure.

The VIN code reading apparatus according to the embodiment of the present disclosure can implement various procedures implemented in FIG. 2, which will not be elaborated herein to avoid repetition.

It should be noted that the above VIN code reading apparatus may execute the VIN code reading method according to the embodiment of the present disclosure, and has corresponding functional modules and beneficial effects for executing the method. For technical details not described in detail in the embodiment of the VIN code reading apparatus, reference may be made to the VIN code reading method according to the above embodiment.

In the embodiment of the present disclosure, a VIN code reading apparatus is provided, including: a first VIN code reader 1001 used for: when a vehicle communication device is powered on, starting a first read VIN code mode of the vehicle communication device, and reading, in the first read VIN code mode, a first VIN code according to preset instructions within the vehicle communication device; and a second VIN code reader 1002 used for: in response to determining that the first VIN code is not successfully read and instructions for stopping the first read VIN code mode or instructions for establishing a communication link sent by a host computer are received, starting a second read VIN code mode, and reading, in the second read VIN code mode, a second VIN code according to a vehicle brand, and thus the present disclosure can reduce the manual operations by a user, and improves VIN code reading efficiency.

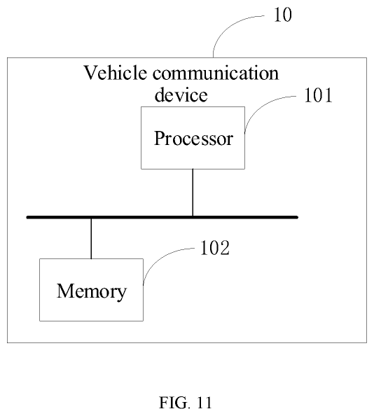

FIG. 11 is a schematic structural diagram of a vehicle communication device according to an embodiment of the present disclosure.

As shown in FIG. 11, the vehicle communication device 10 includes one or more processors 101 and a memory 102, where including one processor 101 is taken as an example in FIG. 11.

The processor 101 and the memory 102 may be connected through a bus or in other modes, and connection through the bus is taken as an example in FIG. 11.

The processor 101 is used for providing computing and control capabilities to control the vehicle communication device 10 to execute corresponding tasks, for example, control the vehicle communication device 10 to execute the VIN code reading method in any one of the above method embodiments, including: when the vehicle communication device is powered on, starting a first read VIN code mode of the vehicle communication device, and reading, in the first read VIN code mode, a first VIN code according to preset instructions within the vehicle communication device; and in response to determining that the first VIN code is not successfully read and instructions for stopping the first read VIN code mode or instructions for establishing a communication link sent by a host computer are received, starting a second read VIN code mode, and reading, in the second read VIN code mode, a second VIN code according to a vehicle brand.

The first read VIN code mode is started and the first VIN code is read when the vehicle communication device is powered on, and if the first VIN code is not successfully read, the second read VIN code mode is executed and the second VIN code is read to correct for the VIN code not being read in the first read VIN code mode, and thus the present disclosure can reduce the manual operations by a user, and improves VIN code reading efficiency.

The processor 101 may be a general-purpose processor, including a Central Processing Unit (CPU), a Network Processor (NP), a hardware chip, or any combination thereof; and the processor 101 may also be a Digital Signal Processor (DSP), an Application-Specific Integrated Circuit (ASIC), a programmable logic device (PLD), or a combination thereof. The above PLD may be a complex programmable logic device (CPLD), a field-programmable gate array (FPGA), a generic array logic (GAL), or any combination thereof.

As a non-transitory computer-readable storage medium, the memory 102 may be used for storing non-transitory software programs, non-transitory computer-executable programs, and modules, such as program instructions/modules corresponding to the VIN code reading method in the embodiments of the present disclosure. The processor 101 may implement the VIN code reading method in any one of the following method embodiments by running the non-transitory software programs, instructions, and modules stored in the memory 102. In an embodiment, the memory 102 may include a volatile memory (VM), such as a random access memory (RAM); the memory 102 may also include a non-volatile memory (NVM), such as a read-only memory (ROM), a flash memory, a hard disk drive (HDD) or a solid-state drive (SSD), or other non-transitory solid-state storage devices; and the memory 102 may also include a combination of the above types of memories.

The memory 102 may include a high-speed random access memory, and may also include a non-volatile memory, such as at least one magnetic disk storage device, a flash memory device, or other non-volatile solid-state storage devices. In some embodiments, the memory 102 may optionally include memories remotely disposed relative to the processor 101, and these remote memories may be connected to the processor 101 through a network. Instances of the above network include but are not limited to, the Internet, an intranet, a local area network, a mobile communication network, and a combination thereof.

One or more modules are stored in the memory 102, and when executed by one or more processors 101, execute the VIN code reading method in any of the above method embodiments, for example, execute various steps shown in FIG. 2 described above; and the modules may also implement the functions of various modules or units in FIG. 10.

In the embodiment of the present disclosure, the vehicle communication device 10 may also have components such as a wired or wireless network interface and an input/output interface to perform input and output. The vehicle communication device 10 may also include other components used for implementing device functions, which will not be elaborated herein.

An embodiment of the present disclosure further provides a non-volatile computer-readable storage medium, such as a memory including program codes, where the above program codes may be executed by a processor to complete the VIN code reading method in the above embodiments. For example, the non-volatile computer-readable storage medium may be a Read-Only Memory (ROM), a Random Access Memory (RAM), a Compact Disc Read-Only Memory (CDROM), a magnetic tape, a floppy disk, and an optical data storage device, and the like.

An embodiment of the present disclosure further provides a computer program product, including one or more program codes, where the program codes are stored in a non-volatile computer-readable storage medium. A processor of an electronic device reads the program codes from the non-volatile computer-readable storage medium, and the processor executes the program codes to complete the method steps of the VIN code reading method provided in the above embodiments.

Those ordinarily skilled in the art may understand that the implementation of all or some of the steps in the above embodiments may be completed by hardware, and may also be completed by hardware related to programs and program codes. The programs may be stored in a non-volatile computer-readable storage medium. The storage medium mentioned above may be a read-only memory, a magnetic disk, or an optical disk, and the like.

From the description of the above embodiments, those ordinarily skilled in the art may clearly understand that various embodiments may be implemented by means of software plus a general hardware platform, and of course, may also be implemented by hardware. Those ordinarily skilled in the art may understand that the implementation of all or part of the flow in the methods of the above embodiments may be completed by instructing related hardware through computer programs, and the programs may be stored in a computer-readable storage medium. The programs, when executed, may include the flow of the embodiments of the various methods above, where the storage medium may be a magnetic disk, an optical disk, a Read-Only Memory (ROM), or a Random Access Memory (RAM), and the like.

The embodiments of the present disclosure provide a VIN code reading method, being applied to a vehicle communication device, the vehicle communication device being communicatively connected to a host computer, and the VIN code reading method including: when the vehicle communication device is powered on, starting a first read VIN code mode of the vehicle communication device, and reading, in the first read VIN code mode, a first VIN code according to preset instructions within the vehicle communication device; and if the first VIN code is not successfully read and instructions for stopping the first read VIN code mode or instructions for establishing a communication link sent by the host computer are received, starting a second read VIN code mode, and reading, in the second read VIN code mode, a second VIN code according to a vehicle brand. The first read VIN code mode of the vehicle communication device is started and the first VIN code is successfully read at the time when the vehicle communication device is powered on and generally the host computer has not been connected yet. Then the vehicle communication device is connected to the host computer, and the host computer automatically acquires the first VIN code read by the vehicle communication device and parses information such as the vehicle brand, model, and production year. When the host computer is a diagnostic terminal, the host computer may automatically open a diagnostic guidance interface for the vehicle according to the parsed information. When the host computer is a server, the host computer may automatically generate a vehicle data monitoring configuration file for subsequent functions according to the parsed information. The above functions may be rapidly and automatically completed at the moment when the vehicle communication device is connected to the host computer, especially when the host computer is the terminal, the user does not need to perform operations such as opening diagnostic software and selecting the vehicle brand, which saves the user's time and helps the user successfully read the VIN code rapidly and enter a correct vehicle brand diagnostic guidance page. If the first VIN code is not successfully read, the second read VIN code mode is executed and the second VIN code is read to correct for the VIN code not being read in the first VIN code mode, and thus the present disclosure can reduce the manual operations by a user, is more automated and intelligent, and improves VIN code reading efficiency.

Finally, it should be noted that the above embodiments are only used for illustrating the technical solutions of the present disclosure, but are not intended to limit them; under the concept of the present disclosure, the technical features in the above embodiments or different embodiments may also be combined with each other, the steps may be implemented in any order, and there are many other variations in different aspects of the present disclosure as described above, which are not provided in details for the sake of brevity; although the present disclosure has been described in detail with reference to the foregoing embodiments, those ordinarily skilled in the art should understand that they can still modify the technical solutions described in the foregoing embodiments, or equivalently replace some of the technical features; and such modifications or replacements do not make the essence of the corresponding technical solutions depart from the scope of the technical solutions of various embodiments of the present disclosure.

What is claimed is:

1. A vehicle identification number (VIN) code reading method, comprising:
when a vehicle communication device is powered on, starting a first read VIN code mode of the vehicle communication device, and reading, in the first read VIN code mode, a first VIN code according to preset instructions within the vehicle communication device, wherein the vehicle communication device is communicatively connected to a host computer; and
in response to determining that the first VIN code is not successfully read and at least one of instructions for stopping the first read VIN code mode or instructions for establishing a communication link sent by the host computer are received, starting a second read VIN code mode, and reading, in the second read VIN code mode, a second VIN code according to a vehicle brand associated with the vehicle.

2. The method according to claim 1, wherein the vehicle communication device is connected to a vehicle diagnostic interface, the first read VIN code mode comprises a forced VIN code reading mode and a rapid VIN code reading mode, and the starting a first read VIN code mode of the vehicle communication device, comprises:
executing the forced VIN code reading mode;
cyclically executing the rapid VIN code reading mode after executing the forced VIN code reading mode;
continuously detecting, in a procedure of executing the forced VIN code reading mode and the rapid VIN code reading mode, whether a VIN code reading termination condition is met, wherein the VIN code reading termination condition comprises successfully reading a VIN code, receiving instructions for establishing a communication link sent by the host computer, receiving instructions for stopping the first read VIN code mode sent by the host computer, or disconnecting the vehicle communication device from the vehicle diagnostic interface; and
in response to determining that the VIN code reading termination condition is met, terminating the first read VIN code mode.

3. The method according to claim 2, wherein the executing the forced VIN code reading mode, comprises:
acquiring a first bus protocol list, wherein the first bus protocol list comprises a plurality of first bus protocols;
acquiring a forced reading instruction list, wherein the forced reading instruction list comprises a plurality of forced reading instructions, and the forced reading instructions are in one-to-one correspondence with the first bus protocols;
sequentially sending the forced reading instructions corresponding to the first bus protocols on at least two of the first bus protocols in accordance with a preset bus protocol order, wherein the forced reading instructions are configured for reading the first VIN code; and
in response to determining that the first VIN code is successfully read, terminating the forced VIN code reading mode.

4. The method according to claim 2, wherein the cyclically executing the rapid VIN code reading mode, comprises:
acquiring a second bus protocol list, wherein the second bus protocol list comprises second bus protocols;
acquiring a rapid reading instruction list, wherein the rapid reading instruction list comprises one or more rapid reading instructions, and the rapid reading instructions are in one-to-one correspondence with the second bus protocols; and
cyclically sending the rapid reading instructions in the rapid reading instruction list on the second bus protocols;
the method further comprises:
in response to determining that the first VIN code is not successfully read in the rapid VIN code reading mode, and instructions for stopping the first read VIN code mode or instructions for establishing a communication link sent by the host computer are received, terminating the first read VIN code mode, and starting the second read VIN code mode to read the second VIN code.

5. The method according to claim 1, wherein the second read VIN code mode comprises a terminal VIN code reading mode and a server VIN code reading mode, and the method further comprises:
when the host computer is a server, determining the second read VIN code mode as the server VIN code reading mode; in response to determining that instructions for stopping the first read VIN code mode sent by the server are received, starting the server VIN code reading mode; and
when the host computer is a terminal, determining the second read VIN code mode as the terminal VIN code reading mode; in response to determining that instructions for establishing a communication link sent by the terminal are received, starting the terminal VIN code reading mode.

6. The method according to claim 5, wherein a vehicle brand configuration file list is preset within the server, and starting the server VIN code reading mode comprises:
acquiring the vehicle brand configuration file list, wherein the vehicle brand configuration file list comprises one or more vehicle brand configuration files;
traversing the vehicle brand configuration file list to acquire a current vehicle brand configuration file;
reading the second VIN code according to the current vehicle brand configuration file, and determining whether the second VIN code is successfully read;
in response to determining that the second VIN code is not successfully read, acquiring a next vehicle brand configuration file in the vehicle brand configuration file list; and
in response to determining that the second VIN code is successfully read, terminating the server VIN code reading mode.

7. The method according to claim 6, wherein the vehicle brand configuration file comprises instructions for establishing a communication link, instructions for entering a system, instructions for reading a VIN code, and execution orders and timing parameters between the instructions for establishing the communication link, the instructions for entering the system and the instructions for reading the VIN code; and the reading the second VIN code according to the current vehicle brand configuration file, comprises:
reading the second VIN code according to the instructions for establishing the communication link, the instructions for entering the system, the instructions for reading the VIN code, and the execution orders and timing parameters between the instructions for establishing the communication link, the instructions for entering the system and the instructions for reading the VIN code.

8. The method according to claim 5, wherein starting the terminal VIN code reading mode, comprises:
establishing a communication link according to instructions for establishing the communication link, wherein the instructions for establishing the communication link comprise communication attributes, and the communication attributes comprise pins, baud rates and bus protocols;
receiving instructions for reading the VIN code sent by the host computer; and
sending the instructions for reading the VIN code to a vehicle electronic controller through the communication link, wherein the vehicle electronic controller returns the second VIN code according to the instructions for reading the VIN code.

9. A vehicle communication device, comprising:
one or more processors; and
a memory communicatively connected to the one or more processors; wherein
the memory stores instructions executable by the one or more processors, and the instructions are executed by the one or more processors to enable the one or more processors to perform acts comprising:
when the vehicle communication device is powered on, starting a first read VIN code mode of the vehicle communication device, and reading, in the first read VIN code mode, a first VIN code according to preset instructions within the vehicle communication device, wherein the vehicle communication device is communicatively connected to a host computer; and
in response to determining that the first VIN code is not successfully read and at least one of instructions for stopping the first read VIN code mode or instructions for establishing a communication link sent by the host computer are received, starting a second read VIN code mode, and reading, in the second read VIN code mode, a second VIN code according to a vehicle brand associated with the vehicle.

10. A non-transitory computer-readable storage medium, having computer programs or instructions stored therein, the computer programs or instructions, when executed by a processor, to enable the processor to perform acts comprising:
when a vehicle communication device is powered on, starting a first read VIN code mode of the vehicle communication device, and reading, in the first read VIN code mode, a first VIN code according to preset instructions within the vehicle communication device, wherein the vehicle communication device is communicatively connected to a host computer; and
in response to determining that the first VIN code is not successfully read and at least one of instructions for stopping the first read VIN code mode or instructions for establishing a communication link sent by the host computer are received, starting a second read VIN code mode, and reading, in the second read VIN code mode, a second VIN code according to a vehicle brand associated with the vehicle.
